(19) United States
(12) Patent Application Publication
(10) Pub. No.: US 2021/0203033 A1
(43) Pub. Date: Jul. 1, 2021

(54) MODULAR MULTIPLE MAGNETIC CONTACT CONNECTABLE SOLID STATE BATTERY BLOCK APPARATUS, A PROCESS THEREOF, AND A METHOD OF USING SAME

(71) Applicant: John T. Walicki, Poughkeepsie, NY (US)

(72) Inventor: John T. Walicki, Poughkeepsie, NY (US)

(21) Appl. No.: 17/135,985

(22) Filed: Dec. 28, 2020

Related U.S. Application Data
(60) Provisional application No. 62/955,374, filed on Dec. 30, 2019.

(51) Int. Cl. H01M 50/258; H01M 10/0562; H01M 50/207; H01M 10/0585

(52) U.S. Cl. CPC H01M 50/258; H01M 10/0585; H01M 50/207; H01M 10/0562

(57) ABSTRACT

The present invention relates generally to a modular multiple magnetic contact connectable solid state battery block apparatus, a process thereof, and a method of using same. More particularly, the invention encompasses a modular magnetic multiple contact connectable solid-state battery block brick that has magnetic polarity, along with electrical polarity so that it can magnetically, and electronically mate with another similar solid-state battery. Each modular solid-state battery is provided with at least one pimple or positive contact protrusion, and at least one dimple or a negative contact detrusion. The modular solid-state battery comes in different shapes and sizes, such as, triangular, rectangular, polygonal, circular, elliptical, etc. The invention also provides a method of using the inventive modular magnetic multiple contact connectable solid state battery block brick or apparatus, so at to form a series of solid-state batteries in order to provide the needed power to electronic device(s).

### CROSS-REFERENCE TO RELATED APPLICATION

The instant patent application claims priority to and the benefit of pending U.S. Provisional Patent Application Ser. No. 62/955,374, filed on Dec. 30, 2019, titled “Modular Magnetic Multi-Contact Solid State Battery Apparatus, Method, And A Process Thereof,” the entire disclosure of which provisional application is incorporated herein by reference.

### FIELD OF THE INVENTION

The present invention relates generally to a modular multiple magnetic contact connectable solid state battery block apparatus, a process thereof, and a method of using same. More particularly, the invention encompasses a modular magnetic multiple contact connectable solid-state battery block brick that has magnetic polarity, along with electrical polarity so that it can magnetically, and electronically mate with another similar solid-state battery. Each modular solid-state battery is provided with at least one pimple or positive contact protrusion, and at least one dimple or a negative contact detrusion. The modular solid-state battery comes in different shapes and sizes, such as, triangular, rectangular, polygonal, circular, elliptical, etc. The invention also provides a method of using the inventive modular magnetic multiple contact connectable solid state battery block brick or apparatus, so at to form a series of solid-state batteries in order to provide the needed power to electronic device(s).

### BACKGROUND INFORMATION

Batteries have been used in the industry for a variety of reasons, and they come in many shapes, sizes, and other physical features and attributes.

This invention improves on the deficiencies of the prior art and provides an inventive modular multiple magnetic contact connectable solid state battery block apparatus, a process thereof, and a method of using same.

### PURPOSES AND SUMMARY OF THE INVENTION

The invention is a novel modular multiple magnetic contact connectable solid state battery block apparatus, a process thereof, and a method of using same.

Therefore, one purpose of this invention is to provide a novel modular multiple magnetic contact connectable solid state battery block apparatus.

Another purpose of this invention is to provide an inventive magnetic spacer connector that connects two novel modular multiple magnetic contact connectable solid state battery block apparatuses.

Yet another purpose of this invention is to provide a modular solid-state battery having different shapes and sizes, such as, triangular, rectangular, polygonal, circular, elliptical, to name a few.

Still yet another purpose of this invention is to provide a modular solid-state battery that is provided with at least one pimple or positive contact protrusion, and at least one dimple or a negative contact detrusion.

Therefore, in one aspect this invention comprises a modular multiple magnetic contact connectable solid state battery block apparatus, comprising:
(a) a solid-state battery having a first surface, a second surface, a third surface, a fourth surface, and a fifth surface, and wherein each of said surfaces are connected along their respective edges to form a solid state battery;
(b) at least one first pair of electrical connection on said first surface; and
(c) at least one second pair of electrical connection on said second surface.

In another aspect this invention comprises a modular multiple magnetic contact connectable solid state battery block apparatus, comprising:
(a) a solid-state battery having a plurality of surfaces, and forming a shape selected from a group consisting of a triangular shape, a square shape, a rectangular shape, a rhombic shape, a circular shape, an elliptical shape, a polygonal shape, an odd shape, an irregular shape, and combinations thereof;
(b) at least one first pair of electrical connection on at least one first surface; and
(c) at least one second pair of electrical connection on at least one second surface, and wherein said second surface is different than said first surface.

### BRIEF DESCRIPTION OF THE DRAWINGS

The invention may best be further understood by reference to the ensuing detailed description in conjunction with the drawings in which:

FIG. 1, illustrates a first embodiment of the modular multiple magnetic contact connectable solid state battery block apparatus.

FIG. 2, illustrates a second embodiment of the modular multiple magnetic contact connectable solid state battery block apparatus.

FIG. 3, illustrates a third embodiment of the modular multiple magnetic contact connectable solid state battery block apparatus.

FIG. 4, illustrates a fourth embodiment of the modular multiple magnetic contact connectable solid state battery block apparatus.

FIG. 5, illustrates an inventive magnetic spacer connector that can be used with the modular multiple magnetic contact connectable solid state battery block apparatus.

FIG. 6, illustrates an exploded view of the inventive magnetic spacer connector that can be used with the modular multiple magnetic contact connectable solid state battery block apparatus.

FIG. 7, illustrates a fifth embodiment of the modular multiple magnetic contact connectable solid state battery block apparatus.

FIG. 8, illustrates a sixth embodiment of the modular multiple magnetic contact connectable solid state battery block apparatus.

FIG. 9, illustrates a seventh embodiment of the modular multiple magnetic contact connectable solid state battery block apparatus.

FIG. 10, illustrates an eighth embodiment of the modular multiple magnetic contact connectable solid state battery block apparatus.

FIG. 11, illustrates a nineth embodiment of the modular multiple magnetic contact connectable solid state battery block apparatus.

FIG. 12, illustrates a tenth embodiment of the modular multiple magnetic contact connectable solid state battery block apparatus.

### DETAILED DESCRIPTION

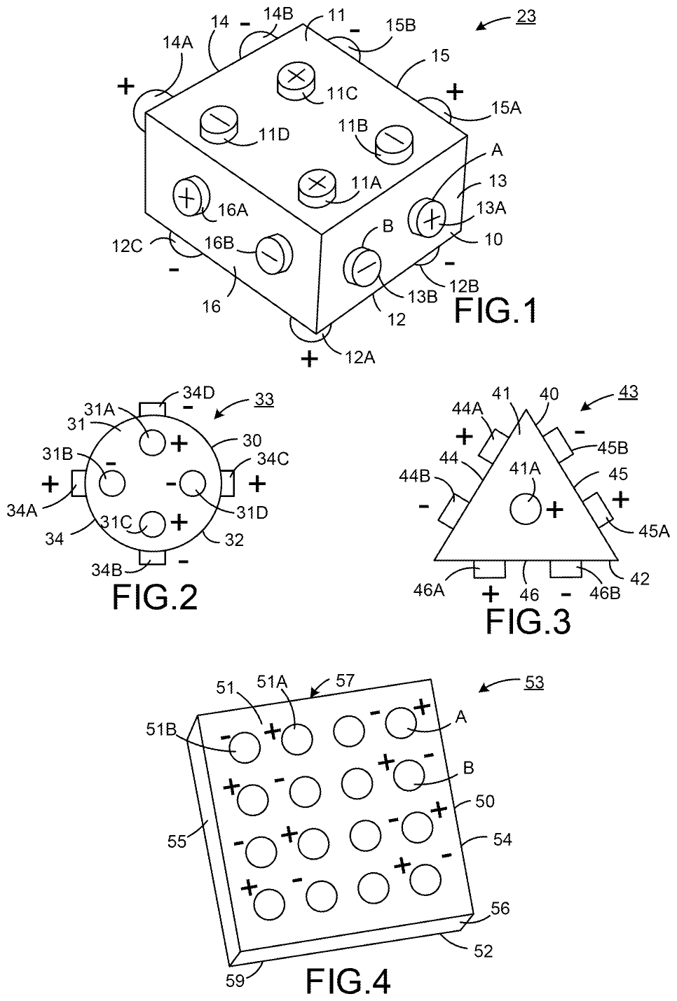

The inventive modular multiple magnetic contact connectable solid state battery block apparatus, a process thereof, and a method of using same will now be discussed with reference to FIGS. 1 through 12. Although the scope of the present invention is much broader than any particular embodiment, a detailed description of the preferred embodiment follows together with drawings. These drawings are for illustration purposes only and are not drawn to scale. Like numbers represent like features and components in the drawings.

The inventive modular multiple magnetic contact connectable solid state battery block apparatus or battery block is a solid-state battery in various forms or shapes with multiple contact terminals. Battery blocks are connected together to form power matrixes that naturally distribute electricity through multiple sets of positive and negative terminals, such as, gold terminals. The inventive battery connectors makes it impossible to connect like terminals together due to proprietary design of “pimples and dimples”. Pimple is a positive electrical contact protrusion, while Dimple is a negative electrical contact detrusion. For some applications the inventive battery contact terminals are recessed into battery block face. For most applications it is preferred that both contact points are spherical. For some applications one could have a Positive terminal as an exterior hemisphere, or protrusion, while the Negative terminal is an interior hemisphere or crater. Essentially, the inventive battery comprises of two parts, namely, a battery portion, and an electrical connector portion.

The inventive modular multiple magnetic contact connectable solid state battery block apparatus or battery block utilizes the novel “Pimple and Dimple” connection process. Additionally, for some applications the recessed battery contacts, and magnetic connectors, snap-fit together firmly connecting a matrix of multiple battery blocks in a daisy chained method, or in series method, or in parallel method. It should be appreciated that all electrical connectors are one way conduits, with one (1) negative end and one (1) positive end.

The inventive modular multiple magnetic contact connectable solid state battery block apparatus or battery block has many potential uses, and applications, such as, for example,

(a) Faster charging in less time for rechargeable battery technology;

(b) Creative methods for DIY model and toy maker hobbyists;

(c) An improved integration of electric vehicles (auto, bike, boat, plane, truck, train);

(d) A new mobile life saving and life support device innovations;

(e) A new industrial design method for product innovations;

(f) A new electrical design method for home, auto and personal devices;

(g) A new computer design method for power management of integrated circuits;

(h) A new photovoltaic design methods for power management and storage capacity, to name a few.

FIG. 1, illustrates a first embodiment of the modular multiple magnetic contact connectable solid state battery block apparatus 23, or a modular magnetic multi-contact solid state battery apparatus 23, where an inventive battery 10, is shaped in a cubic or rectangular or a square shape or polygonal shape, and has a plurality of sides, such as, for example, as shown in FIG. 1, is a polygonal shaped solid state battery 10, having a first or top side surface 11, a second or bottom side surface 12, a third or right side surface 13, a fourth or left side surface 14, a fifth or front side surface 15, and a sixth or back side surface 16. Each of the sides or surfaces of the inventive battery 23, has at least one electrical contact, such as, at least one positive electrical terminal or contact A, and/or at least one negative electrical terminal or contact B. Thus, as shown in FIG. 1, the modular multiple magnetic contact connectable solid state battery block 10, has two positive electrical connections 11A, 11C, and two negative electrical connections 11B, 11D, on the first or top side 11, and two positive electrical connections 12A, 12C (not shown), and two negative electrical connections 12B, 12D, on the second or bottom side 12, and has a positive electrical connections 13A, and negative electrical connections 13B, on the third or right side 13, and has a positive electrical connections 14A, and negative electrical connections 14B, on the fourth or left side 14, and has a positive electrical connections 15A, and negative electrical connections 15B, on the fifth or front side 15, and has a positive electrical connections 16A, and negative electrical connections 16B, on the sixth or back side 16. For the purposes of illustration each of the at least one positive electrical terminal or contact A, and/or at least one negative electrical terminal or contact B, is being shown as protruding in an outwardly direction from the planar surfaces 11, 12, 13, 14, 15, and 16.

FIG. 2, illustrates a second embodiment of the modular multiple magnetic contact connectable solid state battery block apparatus 33, or a modular magnetic multi-contact solid state battery apparatus 33, where the inventive battery 30, is shaped in a round or oval or button shape, and has, for example, a first or top side surface 31, a second or bottom side surface 32, and a third or round side surface 34. Each of the sides or surfaces 31, 32, 34. of the inventive battery 33. has at least one electrical contact or terminal, such as, at least one positive electrical terminal or contact A, and/or at least one negative electrical terminal or contact B. Thus, as shown in FIG. 2, the modular multiple magnetic contact connectable solid state battery block 30, has two positive electrical connections 31A, 31C, and two negative electrical connections 31B, 31D, on the first or top side 31, and has at least one positive electrical connections 32A, (not shown), and at least one negative electrical connections 32B, (not shown) on the second or bottom side 32, and has two positive electrical connections 34A, 34C, and two negative electrical connections 34B, 34D, on the third or round side surface 34.

FIG. 3, illustrates a third embodiment of the modular multiple magnetic contact connectable solid state battery block apparatus 43, or a modular magnetic multi-contact solid state battery apparatus 43, where the inventive battery 40, is shaped in a triangular shape on a peripheral side and has two flat surfaces, such as, for example, a first or top side surface 41, a second or bottom side surface 42, a third or triangular side surface 44, a fourth or triangular side surface 45, a fifth or triangular side surface 46. Each of the triangular sides 44, 45, and 46, of the inventive battery 40, has at least one electrical contact or terminal, such as, at least one positive electrical terminal or contact A, and/or at least one negative electrical terminal or contact B, while the flat or first or top side 41, and the flat or second or bottom side 42, has at least one electrical contact or terminal 41A, 41B, such as, at least one positive electrical terminal or contact 41A, and/or at least one negative electrical terminal or contact 41B. Thus, as shown in FIG. 3, the modular multiple magnetic contact connectable solid state battery block 40, has one positive electrical connections 41A, on the first or top side 41, and a negative electrical connections 42B, (not shown) on the second or bottom side 42, and has a positive electrical connections 44A, and negative electrical connections 44B, on the third or triangular side 44, and has a positive electrical connections 45A, and negative electrical connections 45B, on the fourth or triangular side 45, and has a positive electrical connections 46A, and negative electrical connections 46B, on the fifth or triangular side 46.

FIG. 4, illustrates a fourth embodiment of the modular multiple magnetic contact connectable solid state battery block apparatus 53, or a modular magnetic multi-contact solid state battery apparatus 53, where the inventive battery 50, is shaped in a cubic or rectangular or a square shape and have a plurality of sides, such as, for example, a first or top side 51, a second or bottom side 52, a third or right side 54, a fourth or left side 55, a fifth or front side 56, and a sixth or back side 57. However, in the fourth embodiment 53, the inventive battery 50, has a plurality of a pair of electrical contacts, such as, positive electrical terminal or contact A, and negative electrical terminal or contact B, and where all the pairs of electrical contacts are on the first or top side or surface 51, and where the second or bottom side 52, the third or right side 54, the fourth or left side 55, the fifth or front side 56, and the sixth or back side 57, has no electrical contacts, and thus the second or bottom side or surface 52, acts as a heat sink side 59, for the dissipation of any heat that is generated by the inventive battery 50. For the purposes of illustration only positive electrical contact 51A, and negative electrical contact 51B, is shown in FIG. 4.

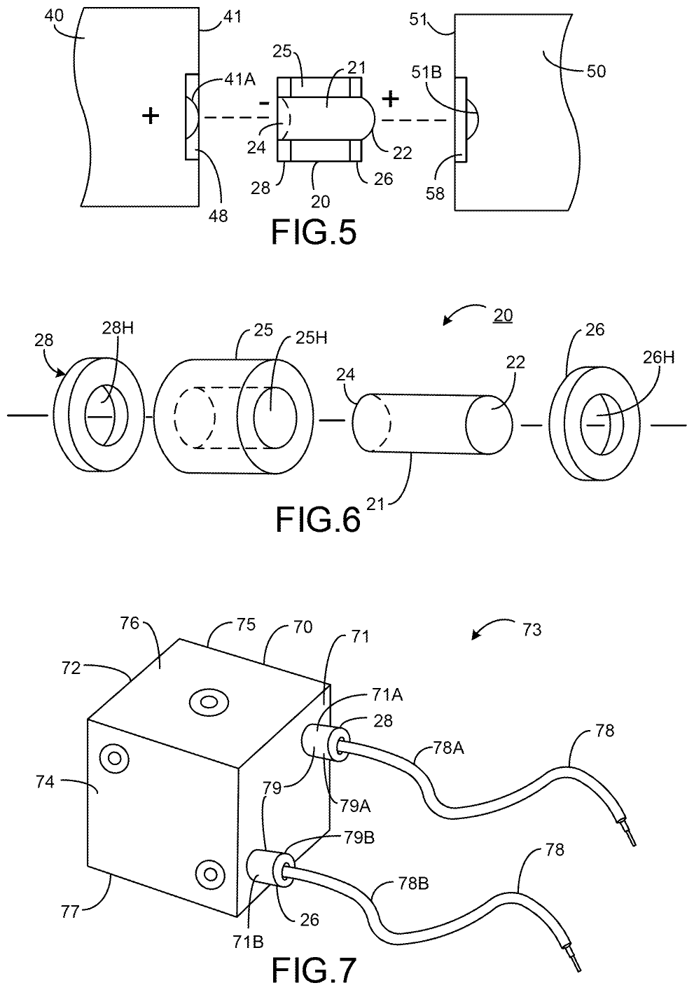

FIG. 5, illustrates an inventive magnetic spacer connector 20, or magnetic grommet connector 20, that can be used with any of the modular multiple magnetic contact connectable solid state battery block apparatus, or a modular magnetic multi-contact solid state battery apparatus. For the purposes of illustration, the inventive magnetic spacer connector 20, is shown to connect the positive terminal 41A, of the side or surface 41, of a first inventive battery, such as, the inventive battery 40, to the negative terminal 51B, of the side or surface 51, of a second inventive battery, such as, the second inventive battery 50. The inventive magnetic spacer connector 20, has at least one electrical connector 21, having a protrusion or a male portion or a pimple 22, and a crater or a female portion or a dimple or a detrusion 24. The electrical connector 21, has at least one non-magnetic non-electrical conductor wrapper or protector or spacer 25, that is preferably over the central portion or surface of the electrical connector 21. For some applications, the at least one non-magnetic non-electrical conductor wrapper or protector or spacer 25, could have an opening or hole 25H, shown in FIG. 6. The electrical connector 21, is provided with at least one first magnet 26, at a first end, such as, at the pimple end 22, and at least one second magnet 28, at a second end, such as, at the dimple end 24. In order to make a magnetic connection with the first battery 40, the first battery 40, is provided with at least one metallic insert or cap or contact ring 48, that is capable of attracting and mating with a magnet, such as, magnet 28. Similarly, in order to make a magnetic connection with the second battery 50, the second battery 50, is provided with at least one metallic insert or cap or contact ring 58, that is capable of attracting and mating with a magnet, such as, magnet 26. Because the inventive magnetic spacer connector 20, has a pimple 22, at one end, and a dimple 24, at the opposite end, therefore, the batteries 40, 50, need to have a corresponding pimple, and dimple, respectively, to allow the inventive magnetic spacer connector 20, to electrically connect the inventive batteries 40, 50, to each other, and to magnetically mate the magnets 26, 28, to magnetically mate with the corresponding metallic insert 48, 58, respectively. Thus, as one can clearly see that the first inventive battery 40, has a positive pimple electrical connection 41A, to electrically connect with the dimple 24, of the inventive magnetic spacer connector 20, while the second inventive battery 50, has a negative dimple electrical connection 51B, to electrically connect with the pimple 22, of the inventive magnetic spacer connector 20. For some applications the metal inserts 48, 58, could be replaced with a magnetic insert 48, 58, and in those situations, care should be taken that inventive magnetic spacer connector 20, has the appropriate magnetic polarity for its magnets 26, 28, so that they attract the corresponding magnets 58, 48, respectively, instead of repelling them, due to the incorrect magnetic pole or polarity. FIG. 5, further illustrates the two magnetic connectors, and the two electrical contacts, namely, the positive terminal (pimple) 22, the negative terminal (dimple) 24, the electrically conductive solid gold connector shaft 21, metal contact rings 48, 58, magnetic contact rings 26, 28, and ceramic sheath casing 25. Thus, the inventive magnetic spacer connector 20, provides a plug and play, or a snap fit connection between any two inventive modular multiple magnetic contact connectable solid state batteries, along with providing a space for the dissipation of any heat energy that might be generated by any of the connected modular multiple magnetic contact connectable solid state batteries.

FIG. 6, illustrates an exploded view of the inventive magnetic spacer connector 20, that can be used with any of the modular multiple magnetic contact connectable solid state battery block apparatus, or a modular magnetic multi-contact solid state battery apparatus. The inventive magnetic spacer connector 20, has at least one electrical connector 21, having a protrusion or a male portion or a pimple 22, and a crater or a female portion or a dimple or a detrusion 24. The electrical connector 21, has at least one non-magnetic non-electrical conductor wrapper or protector 25, that is preferably over the central portion or surface of the electrical connector 21. The at least one non-magnetic non-electrical conductor wrapper or protector or spacer 25, creates or provides an opening or hole 25H. The electrical connector 21, is provided with at least one first magnet 26, having a central opening or hole 26H, at a first end, such as, at the pimple end 22, and at least one second magnet 28, having a central opening or hole 28H, at a second end, such as, at the dimple end 24. The inventive magnetic spacer connector 20, can also be utilized to give enough separation between each inventive battery block so as to allow airflow and reduce or help dissipate any heat produced by each battery block. For some applications the inventive magnetic spacer connector is provided with a ceramic encasing 25. The inventive magnetic spacer connector 20, comprises of essentially of three parts, namely, (a) a solid gold interior shaft 21, with pimple 22, and dimple 24, at ends, (b) a ceramic casing 25, protecting the gold shaft 21, and (c) magnet rings 26, 28, at each end of the connector tube or shaft 21. It should be appreciated that the ceramic casing 25, reduces heat retention in the connector 21, and in the airspace between battery blocks, that might otherwise increase electron flow between connected inventive modular batteries and/or cause damage or explosion. For some applications the magnet rings 26, are oriented with south polarity facing Negative terminal or connection, and with the magnet rings 28, being oriented with north polarity facing Positive terminal or connection. FIG. 6, further shows the exploded view of the connector 20, having a rear magnet ring (negative contact) 28, a ceramic casing sheath 25, a solid gold connector shaft 21, and a front magnet ring (positive contact) 26, which is more clearly shown in FIG. 5.

FIG. 7, illustrates a fifth embodiment of the modular multiple magnetic contact connectable solid state battery block apparatus 73, or a modular magnetic multi-contact solid state battery apparatus 73, where the inventive battery 70, is shaped in a cubic or rectangular or a square shape or a polygonal shape and has a plurality of sides, such as, for example, a first or top side 71, a second or bottom side 72, a third or right side 74, a fourth or left side 75, a fifth or front side 76, and a sixth or back side 77. The inventive battery 70, is provided with an electrical connector 79, having electrical leads 78, thus, for example, the electrical connector 79, has an electrical plug 79A, having a positive electrical lead 78A, that electrically connects with, for example, a positive electrical connection 71A, and similarly, the electrical connector 79, has an electrical plug 79B, having a negative electrical lead 78B, that electrically connects with, for example, a negative electrical connection 71B. The inventive battery 70, is shown in FIG. 7, as a cube battery block with Positive connector 71A, and Negative Connector 71B, with wires 78A, 78B, respectively, attached for a circuit network integration. It should be appreciated that for some applications the connecting end of the electrical connector 79, could have at least one magnet 26, 28, so as to provide a secure magnetic connection to the electrical connection 71A, 71B, similar to the electrical and magnetic connection as shown, for example in FIG. 5. In such situations one has to make sure that the electrical connector 79, having the magnetic material 26, 28, has the right pole polarity, or opposite pole polarity, so as to attract the connector magnet 26, 28, and not to repeal them due to both having the same pole polarity. FIG. 7, shows a 3D Cube Battery Block 73.

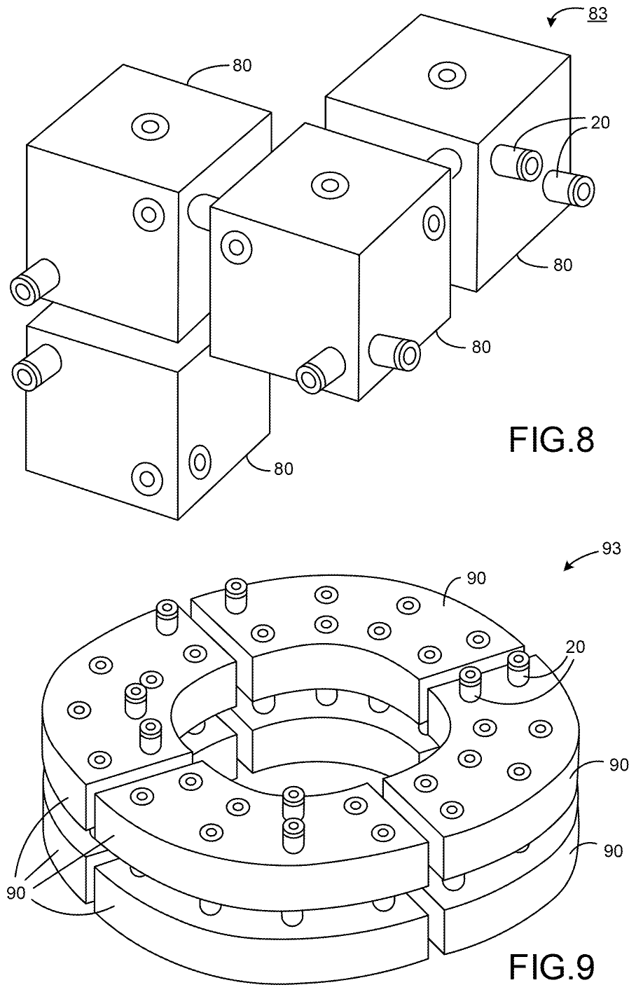

FIG. 8, illustrates a sixth embodiment of the modular multiple magnetic contact connectable solid state battery block apparatus 83, or a modular magnetic multi-contact solid state battery apparatus 83, where the inventive battery 80, is shaped in a cubic or rectangular or a square shape or a polygonal shape and has a plurality of sides. FIG. 8, illustrates a plurality of the inventive batteries 80, being connected each to the other in a random fashion. As one can appreciate that plurality of batteries 80, when electrically connected provide an increased amount of electrical charge or DC (direct current) voltage.

FIG. 9, illustrates a seventh embodiment of the modular multiple magnetic contact connectable solid state battery block apparatus 93, or a modular magnetic multi-contact solid state battery apparatus 93, where the inventive battery 90, is shaped in a plurality of arches or quarter circular or quarter elliptical manner. FIG. 9, illustrates a plurality of the inventive batteries 90, being connected each to the other in a circular or elliptical fashion. As one can appreciate that plurality of batteries 90, when electrically connected provide an increased amount of electrical charge or DC (direct current) voltage. It should be appreciated that the inventive batteries 90, could all be one unit or piece so as to form a circular battery 90, or an elliptical battery 90.

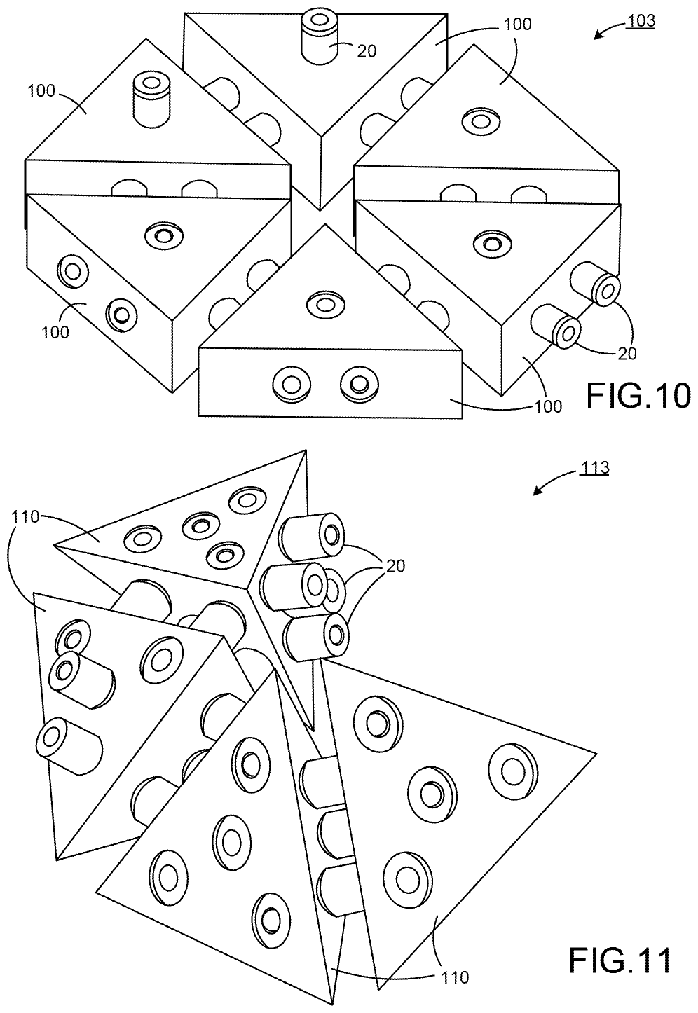

FIG. 10, illustrates an eighth embodiment of the modular multiple magnetic contact connectable solid state battery block apparatus 103, or a modular magnetic multi-contact solid state battery apparatus 103, where the inventive battery 100, is shaped in a triangular shape. FIG. 10, illustrates a plurality of the inventive batteries 100, being connected each to the other in a polygonal fashion. As one can appreciate that plurality of batteries 100, when electrically connected provide an increased amount of electrical charge or DC (direct current) voltage. It should be appreciated that the inventive batteries 100, could all be one unit or piece so as to form a polygonal battery 100, or a hexagonal battery 100.

FIG. 11, illustrates a nineth embodiment of the modular multiple magnetic contact connectable solid state battery block apparatus 113, or a modular magnetic multi-contact solid state battery apparatus 113, where the inventive battery 110, is shaped in a tetrahedron shape. FIG. 11, illustrates a plurality of the inventive batteries 110, being connected each to the other in a series fashion. As one can appreciate that plurality of batteries 110, when electrically connected provide an increased amount of electrical charge or DC (direct current) voltage.

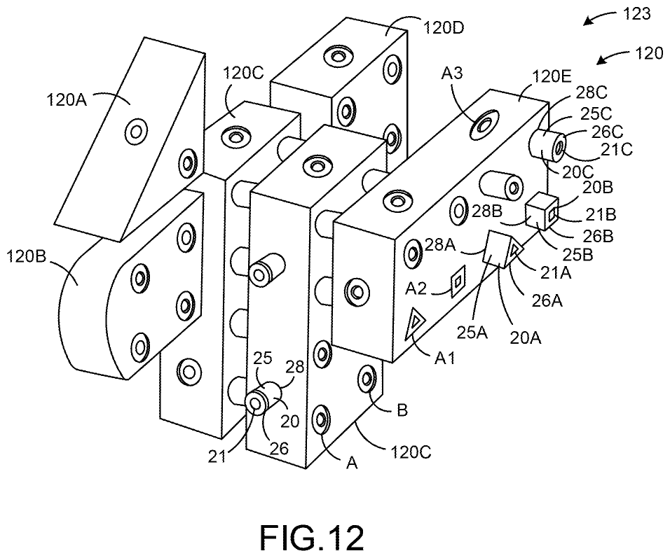

FIG. 12, illustrates a tenth embodiment of the modular multiple magnetic contact connectable solid state battery block apparatus 123, or a modular magnetic multi-contact solid state battery apparatus 123, where a plurality of inventive batteries 120, are electrically connected in a random shape. For the purposes of illustration, the inventive batteries 120, comprise of a triangular shaped battery 120A, an odd or mixed shape 120B, a rectangular or polygonal shape 120C, a square or cubic shape 120D, a rectangular or polygonal shape 120E. FIG. 12, also illustrates that the positive pimple electrical connection A, can have different cross-sectional shapes, such as, a triangular shape A1, square or polygonal shape A2, a circular or elliptical shape A3, to name a few. It should be understood that the cross-sectional shape for the negative dimple electrical connection B, would be similar to, or same as, the cross-sectional shape of the positive pimple electrical connection A, and for the ease of understanding is not illustrated in FIG. 12. FIG. 12, also illustrates that the cross-sectional shape for the inventive magnetic spacer connector 20, could also have different cross-sectional shapes, such as, for example, a triangular shape 20A, a rectangular or polygonal shape 20B, a circular or elliptical shape 20C, to name a few. Thus, the inventive triangular shape magnetic spacer connector 20A, would have a triangular shape electrical connector 21A, along with a triangular shape spacer or washer or magnet 26A, 28A, and a triangular shape non-electrical conductor protector or spacer 25A. Similarly, the inventive rectangular or polygonal shape magnetic spacer connector 20B, would have a rectangular or polygonal shape electrical connector 21B, along with a rectangular or polygonal shape spacer or washer or magnet 26B, 28B, and a rectangular or polygonal shape non-electrical conductor protector or spacer 25B. And, similarly, the inventive circular or elliptical shape magnetic spacer connector 20C, would have a circular or elliptical shape electrical connector 21C, along with a circular or elliptical shape spacer or washer or magnet 26C, 28C, and a circular or elliptical shape non-electrical conductor protector or spacer 25C. FIG. 12, further illustrates a plurality of the inventive batteries 120, being connected each to the other in a series and parallel fashion. As one can appreciate that plurality of batteries 120, when electrically connected provide an increased amount of electrical charge or DC (direct current) voltage.

It should be appreciated that each of the electrical contacts have magnetic capabilities, such as, for example, the positive electrical contact acts as a north magnetic pole, while the negative electrical contact acts as a south magnetic pole, so that north magnetic pole would automatically attract an electrical terminal having a south magnetic pole, to not only establish an electrical contact, but also a magnetic contact, with an electrical mating device or a second inventive battery.

Thus, as one can appreciate one can connect the inventive batteries in series or parallel to each other or stack them one on top of the other, so as to provide a higher electrical power to any connected electrical device or mated batteries.

Because each of the electrical terminals have magnetic capabilities one does not need to worry about the electrical connection between a first electrical device or battery, and the connecting second electrical device or battery.

Thus, the inventive batteries provide a “plug and play” capabilities, and are easily replaceable, such as, by tiling and/or stacking, and can be termed “smartest battery ever”.

This inventive multi-contact battery has many uses, such as, for example, industrial use, residential use, commercial use, use in electrical devices, use in motorized vehicles, to name a few.

This inventive multi-contact magnetic battery allows for direct and natural distribution of power, and a creative CPU design.

It should be understood that the features recited in the description are interchangeable, and for the sake of convenience each of these inventive features are not repeated with the description of each feature.

It should be understood that the brief description of the invention is for illustration purposes only, and one could have other variations of this invention which are well known to a person skilled in the art.

It should be appreciated that the inventive battery block could have a variety of sizes, and shapes, some of the more popular shapes are a cube with six (6) electrical contacts, one on each surface, a cube with ten (10) electrical contacts, a slab with twelve (12) contacts, a long slab with twenty two (22) electrical contacts, a beam with eighteen (18) electrical contacts, a triangle with eight (8) electrical contacts, an arch with twenty (20) electrical contacts, a tetrahedron with sixteen (16) electrical contacts, to name a few. These electrical contacts could be a single electrical contact or a pair of electrical contact comprising of a positive electrical contact A, and a negative electrical contact B. A user can have as many of electrical contact as they desire or as many as the inventive battery could accommodate without creating a structural or hazardous situation.

For the ease of understanding the cross-sectional shape for the at least one pimple 22, and dimple 24, has been shown as round or semispherical, however, a person skilled in the art could also use a cross-sectional shape for the at least one pimple 22, or dimple 24, could be selected from a group comprising a triangular shape, a square shape, a rectangular shape, a rhombic shape, a circular shape, an elliptical shape, a polygonal shape, an odd shape, an irregular shape, and combinations thereof, to name a few.

Similarly, for the ease of understanding the cross-sectional shape for the at least one positive electrical connection A, and the at least one negative electrical connection B, has been shown as round or semispherical, however, a person skilled in the art could also use a cross-sectional shape for the at least one positive electrical connection A, and the at least one negative electrical connection B, could be selected from a group comprising a triangular shape, a square shape, a rectangular shape, a rhombic shape, a circular shape, an elliptical shape, a polygonal shape, an odd shape, an irregular shape, and combinations thereof, to name a few, and this would directly correspond with the cross-sectional shape of the corresponding at least one pimple 22, or at least one dimple 24, that is going to be electrically connected to the at least one positive electrical connection A, or the at least one negative electrical connection B.

The cross-sectional area for the inventive magnetic spacer connector 20, can be selected from a group comprising a triangle, a square, a rectangle, a circle, an oval, a polygonal shape, a cylindrical shape, and combinations thereof, to name a few.

The material for the at least one non-magnetic non-electrical conductor wrapper or protector or spacer 25, could be selected from a group comprising ceramic, glass, quartz, synthetic sapphire, polymeric material, composite material, and combinations thereof, to name a few.

The material for the at least one electrical connector 21, could be selected from a group comprising gold, silver, copper, aluminum, an electrically conducting polymeric material, an electrically conducting composite material, and combinations thereof, to name a few.

The material for the at least one magnetic spacer or washer 26, 28, could be selected from a group comprising, a magnet, a neodymium magnet, a magnetic washer, a magnetic composite, and combinations thereof, to name a few.

The cross-sectional shape for the at least one magnetic spacer or washer 26, 28, could be selected from a group comprising a triangular shape, a square shape, a rectangular shape, a rhombic shape, a circular shape, an elliptical shape, a polygonal shape, an odd shape, an irregular shape, and combinations thereof, to name a few.

Thus, the present invention is not limited to the embodiments described herein and the constituent elements of the invention can be modified in various manners without departing from the spirit and scope of the invention. Various aspects of the invention can also be extracted from any appropriate combination of a plurality of constituent elements disclosed in the embodiments. Some constituent elements may be deleted in all of the constituent elements disclosed in the embodiments. The constituent elements described in different embodiments may be combined arbitrarily.

Still further, while certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions.

It should be further understood that throughout the specification and claims several terms have been used and they take the meanings explicitly associated herein, unless the context clearly dictates otherwise. For example, the phrase “in one embodiment” as used herein does not necessarily refer to the same embodiment, though it may. Additionally, the phrase “in another embodiment” as used herein does not necessarily refer to a different embodiment, although it may. Thus, various embodiments of the invention may be readily combined, without departing from the scope or spirit of the invention.

While the present invention has been particularly described in conjunction with a specific preferred embodiment, it is evident that many alternatives, modifications and variations will be apparent to those skilled in the art in light of the foregoing description. It is therefore contemplated that the appended claims will embrace any such alternatives, modifications and variations as falling within the true scope and spirit of the present invention.

What is claimed is:

1. A modular multiple magnetic contact connectable solid state battery block apparatus, comprising:
(a) a solid state battery having a first surface, a second surface, a third surface, a fourth surface, and a fifth surface, and wherein each of said surfaces are connected along their respective edges to form a solid state battery;
(b) at least one first pair of electrical connection on said first surface; and
(c) at least one second pair of electrical connection on said second surface.

2. The modular multiple magnetic contact connectable solid state battery block apparatus of claim 1, wherein said first pair of electrical connections comprises of a pimple positive electrical connection, and a dimple negative electrical connection.

3. The modular multiple magnetic contact connectable solid state battery block apparatus of claim 1, wherein said first pair of electrical connections comprises of a positive electrical connection, and a negative electrical connection, and wherein said positive electrical connection has secured thereto at least one magnetic connection having a first polarity, and wherein said negative electrical connection has secured thereto at least one magnetic connection having a second polarity.

4. The modular multiple magnetic contact connectable solid state battery block apparatus of claim 1, wherein said at least one first pair of electrical connection on said first surface has a cross-sectional shape which is selected from a group consisting of a triangular shape, a square shape, a rectangular shape, a rhombic shape, a circular shape, an elliptical shape, a polygonal shape, an odd shape, an irregular shape, and combinations thereof.

5. The modular multiple magnetic contact connectable solid state battery block apparatus of claim 1, wherein said first pair of electrical connections comprises of a positive electrical connection, and a negative electrical connection, and wherein a first magnetic spacer connector is electrically connected to said positive electrical connection, and a second magnetic spacer connector is electrically connected to said negative electrical connection.

6. The modular multiple magnetic contact connectable solid state battery block apparatus of claim 1, wherein said first pair of electrical connections comprises of a positive electrical connection, and a negative electrical connection, and wherein a first magnetic spacer connector is electrically connected to said positive electrical connection, and a second magnetic spacer connector is electrically connected to said negative electrical connection, and wherein said first magnetic spacer connector comprises of a central electrical connection shaft, protected by at least one non-electrically conductor spacer, with a first magnet at one end, and a second magnet at the opposite end.

7. The modular multiple magnetic contact connectable solid state battery block apparatus of claim 1, wherein said first pair of electrical connections comprises of a positive electrical connection, and a negative electrical connection, and wherein a first magnetic spacer connector is electrically connected to said positive electrical connection, and a second magnetic spacer connector is electrically connected to said negative electrical connection, and wherein said second magnetic spacer connector comprises of a central electrical connection shaft, protected by at least one non-electrically conductor spacer, with a first magnet at one end, and a second magnet at the opposite end.

8. The modular multiple magnetic contact connectable solid state battery block apparatus of claim 1, wherein said first pair of electrical connections comprises of a pimple positive electrical connection, and a dimple negative electrical connection, and wherein said first pair of electrical connections is coplanar with said first surface.

9. The modular multiple magnetic contact connectable solid state battery block apparatus of claim 1, wherein said first pair of electrical connections comprises of a pimple positive electrical connection, and a dimple negative electrical connection, and wherein said first pair of electrical connections is below the planar surface of said first surface.

10. The modular multiple magnetic contact connectable solid state battery block apparatus of claim 1, wherein said first pair of electrical connections comprises of a pimple positive electrical connection, and a dimple negative electrical connection, and wherein said first pair of electrical connections protrudes above the planar surface of said first surface.

11. A modular multiple magnetic contact connectable solid state battery block apparatus, comprising:
(a) a solid state battery having a plurality of surfaces, and forming a shape selected from a group consisting of a triangular shape, a square shape, a rectangular shape, a rhombic shape, a circular shape, an elliptical shape, a polygonal shape, an odd shape, an irregular shape, and combinations thereof;
(b) at least one first pair of electrical connection on at least one first surface; and
(c) at least one second pair of electrical connection on at least one second surface, and wherein said second surface is different than said first surface.

12. The modular multiple magnetic contact connectable solid state battery block apparatus of claim 11, wherein said first pair of electrical connections comprises of a pimple positive electrical connection, and a dimple negative electrical connection.

13. The modular multiple magnetic contact connectable solid state battery block apparatus of claim 11, wherein said first pair of electrical connections comprises of a positive electrical connection, and a negative electrical connection, and wherein said positive electrical connection has secured thereto at least one magnetic connection having a first polarity, and wherein said negative electrical connection has secured thereto at least one magnetic connection having a second polarity.

14. The modular multiple magnetic contact connectable solid state battery block apparatus of claim 11, wherein said at least one first pair of electrical connection on said first surface has a cross-sectional shape which is selected from a group consisting of a triangular shape, a square shape, a rectangular shape, a rhombic shape, a circular shape, an elliptical shape, a polygonal shape, an odd shape, an irregular shape, and combinations thereof.

15. The modular multiple magnetic contact connectable solid state battery block apparatus of claim 11, wherein said first pair of electrical connections comprises of a positive electrical connection, and a negative electrical connection, and wherein a first magnetic spacer connector is electrically connected to said positive electrical connection, and a second magnetic spacer connector is electrically connected to said negative electrical connection.

16. The modular multiple magnetic contact connectable solid state battery block apparatus of claim 11, wherein said first pair of electrical connections comprises of a positive electrical connection, and a negative electrical connection, and wherein a first magnetic spacer connector is electrically connected to said positive electrical connection, and a second magnetic spacer connector is electrically connected to said negative electrical connection, and wherein said first magnetic spacer connector comprises of a central electrical connection shaft, protected by at least one non-electrically conductor spacer, with a first magnet at one end, and a second magnet at the opposite end.

17. The modular multiple magnetic contact connectable solid state battery block apparatus of claim 11, wherein said first pair of electrical connections comprises of a positive electrical connection, and a negative electrical connection, and wherein a first magnetic spacer connector is electrically connected to said positive electrical connection, and a second magnetic spacer connector is electrically connected to said negative electrical connection, and wherein said second magnetic spacer connector comprises of a central electrical connection shaft, protected by at least one non-electrically conductor spacer, with a first magnet at one end, and a second magnet at the opposite end.

18. The modular multiple magnetic contact connectable solid state battery block apparatus of claim 11, wherein said first pair of electrical connections comprises of a pimple positive electrical connection, and a dimple negative electrical connection, and wherein said first pair of electrical connections is coplanar with said first surface.

19. The modular multiple magnetic contact connectable solid state battery block apparatus of claim 11, wherein said first pair of electrical connections comprises of a pimple positive electrical connection, and a dimple negative electrical connection, and wherein said first pair of electrical connections is below the planar surface of said first surface.

20. The modular multiple magnetic contact connectable solid state battery block apparatus of claim 11, wherein said first pair of electrical connections comprises of a pimple positive electrical connection, and a dimple negative electrical connection, and wherein said first pair of electrical connections protrudes above the planar surface of said first surface.
